(19) United States
(12) Patent Application Publication
(10) Pub. No.: US 2013/0270456 A1
(43) Pub. Date: Oct. 17, 2013

(54) METHOD AND DEVICE FOR HUNTERS SAFETY ALONG TRAILS LEADING TO A HUNTING AREA IN THE DARK

(71) Applicant: Horace Clifton Edwards, Franklinton, NC (US)

(72) Inventor: Horace Clifton Edwards, Franklinton, NC (US)

(21) Appl. No.: 13/447,387

(22) Filed: Apr. 16, 2012

(51) Int. Cl. G01N 21/64

(52) U.S. Cl. 250/459.1; 250/461.1

(57) ABSTRACT

The present invention relates to a method for hunter's safety to allow them to find

### COPYRIGHT NOTICE

A portion of the disclosure of this patent contains material that is subject to copyright protection. The copyright owner has no objection to the reproduction by anyone of the patent document or the patent disclosure as it appears in the Patent and Trademark Office patent files or records, but otherwise reserves all copyright rights whatsoever.

### BACKGROUND OF THE INVENTION

1. Field of the Invention

The present invention relates to devices and methods for hunter safety and helping hunters find their way in the dark to hunting areas. Specifically the invention relates to creating a continuous lighted path in the dark for a hunter for finding their way from a start location to a finish location, such as a hunting stand.

2. Description of Related Art

The safety of hunters is more difficult at night due to conditions at hunting locations which may make it pitch black. During the day or brightly moonlit nights, a hunter can traverse a chosen path and determine that is free from obstacles and such path is otherwise safe to traverse since the hunter can easily stay on a safe path. If it is dark out, the hunter can park their car and walk to a hunting blind or other destination and even if only a few hundred feet away, the hunter can run into serious problems even death if they lose their way in the dark or trip and fall injuring themselves or accidently discharging their weapon, if they walk off course or encounter debris on the path. Many blinds can be a half mile or a mile or more from the starting point, increasing the likelihood of an accident occurring.

A number of methods are currently utilized including reflective signs, reflective tape tied around trees, and in more complicated systems, electrically illuminated paths and illuminated signs. Attempts have been made over the past decades to solve this problem and there have been continuous further attempts to provide such night time pathway marking. For example, recently in US patent application publication 2010/0154263 to Riverio, a hunter safety apparatus is disclosed which includes a safety sign to store reflective pins which are used by the hunters to find their way to the hunting area by utilizing placement of the pins along the pathway.

While these devices, systems, and methods have been around in some cases for decades and in other cases recently introduced, they all suffer in that they require one or more internal power source, great expense, easily lost, easily hidden, and/or are placed at intervals. If one of the interval placed devices is covered (e.g. by leaves or pine straw) or moved (e.g. by an animal in the area), one is faced once again with trying to find their way in the dark to the next reflective device. Some devices are so large that they intrude on the purity of the woods and hunter's area and can even interrupt animal life especially self lighted devices.

In the case of when the hunter reaches the hunting area which consists of a hunter's blind with staircases or ladders, the exact location of the steps or rungs on the ladder can be a problem and single reflective devices even on each step do not give the depth perception of the steps needed to know exactly where the steps are in pitch black conditions. A mistake while holding a firearm and climbing stairs or ladder rungs at the same time in the dark has in many cases caused serious injury and death to hunters who make a misstep on the ladder or steps.

It is clear that there is still room for improvement in creating a safe and easy way for hunters to move in the dark along a trail or path to a hunting area like a hunter's blind and for entering a raised hunter's blind in the dark.

### BRIEF SUMMARY OF THE INVENTION

The present invention relates to a system and method of marking the trail from a starting location to a hunting area, such as a hunter's blind, by utilizing a continuous piece of UV fluorescence reflective string between the starting and hunting area. It is cheap, easy to use, and overcomes much of the above identified problems. Further, where steps or rungs of a ladder are involved such as with a raised hunter's blind, wrapping the string around each step allows for depth perception of the size and depth of the stair or rung. The string, normally invisible at night even with use of a regular flashlight, can be seen by the hunter who carries a simple UV light such as an LED UV flashlight so that minimal problems with surrounding animals occur since animals cannot detect UV light as well as full spectrum flashlight light. In addition, if a portion of the string becomes covered, merely lifting up on the portion that can be seen will reveal the path of the string and location of an obstruction or problem.

Accordingly in one embodiment, the invention relates to a method of providing a marking of an outdoor trail for a hunter at night, the trail extending from a trail starting point to a hunting area along the trail comprising:
a) selecting string that fluoresces under UV light the string having a first and second end;
b) positioning the first end of the string at the starting point and running a continuous length of the string along the trail and positioning the second end at the hunting area;
c) providing a portable UV flashlight to the hunter; and
d) the hunter shining the light on the string and following along the string from one end of the string to the other end of the string.

In yet another embodiment the present invention relates to a system for providing a safe passage for a hunter traversing along an outdoor trail in the dark between a starting point and a hunting area comprising:
a) UV fluorescent string having a first end and a second end of a length sufficient to extend from the starting point to the hunting area along the trail;
b) a portable UV flashlight; and
c) instructions for the hunter for positioning the first end of the string at the starting point and the second end at the hunting area along the trail and utilizing the UV flashlight to find one's way between the starting point and hunting area.

### BRIEF DESCRIPTION OF THE DRAWINGS

FIG. 1 is a drawing of a hunter using a UV flashlight to follow a string laid along a trail to a hunter's blind.

FIG. 2 is a system or Kit-of parts for providing a safe path along a trail in darkness.

### DETAILED DESCRIPTION OF THE INVENTION

While this invention is susceptible to embodiment in many different forms, there is shown in the drawings and will herein be described in detail specific embodiments, with the understanding that the present disclosure of such embodiments is to be considered as an example of the principles and not intended to limit the invention to the specific embodiments shown and described. In the description below, like reference numerals are used to describe the same, similar or corresponding parts in the several views of the drawings. This detailed description defines the meaning of the terms used herein and specifically describes embodiments in order for those skilled in the art to practice the invention.

The terms “a” or “an”, as used herein, are defined as one or as more than one. The term “plurality”, as used herein, is defined as two or as more than two. The term “another”, as used herein, is defined as at least a second or more. The terms “including” and/or “having”, as used herein, are defined as comprising (i.e., open language). The term “coupled”, as used herein, is defined as connected, although not necessarily directly, and not necessarily mechanically.

As used herein the terms “about” and “essentially” refer to ±10%.

Reference throughout this document to “one embodiment”, “certain embodiments”, and “an embodiment” or similar terms means that a particular feature, structure, or characteristic described in connection with the embodiment is included in at least one embodiment of the present invention. Thus, the appearances of such phrases or in various places throughout this specification are not necessarily all referring to the same embodiment. Furthermore, the particular features, structures, or characteristics may be combined in any suitable manner in one or more embodiments without limitation.

The term “or” as used herein is to be interpreted as an inclusive or meaning any one or any combination. Therefore, “A, B or C” means any of the following: “A; B; C; A and B; A and C; B and C; A, B and C”. An exception to this definition will occur only when a combination of elements, functions, steps or acts are in some way inherently mutually exclusive.

The drawings featured in the figures are for the purpose of illustrating certain convenient embodiments of the present invention, and are not to be considered as limitation thereto. Term “means” preceding a present participle of an operation indicates a desired function for which there is one or more embodiments, i.e., one or more methods, devices, or apparatuses for achieving the desired function and that one skilled in the art could select from these or their equivalent in view of the disclosure herein and use of the term “means” is not intended to be limiting or used in a limiting way.

As used herein the term “marking an outdoor trail” refers to a path that exists from a starting point on the trail to a hunting area that has a means for a hunter to find his way along the outdoor trail in the dark. A trail is a path, walkway, or the like, in an outdoor setting. Typically, a hunter carrying his/her weapon parks the car near an area the hunter wishes to hunt from. The hunter walks from the car or other starting location through an outdoor location along a path for hunting such as the woods, fields, mountain paths, and the like to the desired area. In many cases, the hunter will have established a hunter's blind as the hunting area, a structure to hide from the desired game animal target such as a deer and be protected to some extend from the elements. Normally a hunter following a trail or path during the daylight hours has no problem. However, after sunset if there is no night lights, moon, or stars (such as during an overcast night), the path may be pitch black and nothing is visible. A regular flashlight might be of aid but would scare away deer and other game targets. A trail is then marked such that the hunter can find their way to and from the starting point and the hunting area without wondering off the trail or stumbling on something in the trail and done so in a manner that targets are not scared off. As mentioned above, for decades the only method of trail marking has been intermittent signage, ribbons or the like or electric marking which is expensive and can scare game away from the site. The trail will have a particular length between the starting point and the hunting area which can easily be measured by one skilled in the art.

As used herein the term “hunting blind” refers to a structure set up in a hunting area for hunting for a game animal. It can be positioned on the ground or raised in the air and accessible via stairs or a ladder.

As used herein the term “string that fluoresces under UV light” refers to a cord, rope, string, thread, yarn or the like that is treated such that it fluoresces when a UV light is shone on it. A number of different materials are available for manufacturing such string, including strings made from nylon, Polyvinyl chloride (PVC) or the like. The string will have a first end and a second end like any string and pieces of string can be attached at their ends to form a single string of a desired length. The length of string utilized is sufficient to run the length of the trail. The first end of the string is positioned at the starting point and a continuous length of the string is run along the trail with the second end positioned at a desired area at the hunting area.

The string can be positioned by staking the string along the ground, tying it to trees and bushes along the trail or any method or combination of methods to produce a continuous string along the trail. The string can be on a roll and one merely dispenses the string or a device used to roll out the string as the string is laid down. In most cases the string will be laid during daylight hours so its exact position along the trail can be properly determined.

In the event the hunting area is a hunter's blind and the blind is elevated, the string can be run up the stairs or ladder with the string wrapped around each stair or rung of the stairs or ladder, in one embodiment, so that the step's or rung's dimensions can be seen more clearly in the dark. The second end could end where desired, but in one embodiment at the hunter's blind door. In one embodiment, a length of string could be left to use to tie around the hunter's weapon so that the weapon could be raised or lowed to the door of the raised blind and the hunter is clear where the gun is during the process.

As used herein the term “UV light” refers to a portable (DC battery operated) flashlight type device which only produces a light in arrangement of about 380 to 400 nm (UV). Because animals have difficulty seeing UV light range compared with normal flashlight light, it is much less likely to cause a problem with game animals seeing the light and being scared off. In one embodiment, the flashlight is a UV LED flashlight having one or more UV LED bulbs.

The hunter finds his way using the method and system of the invention by starting at the first or second end of the string and shinning the UV light on the end of the string and then following the string to the opposite end. Since the string is positioned along the trail the hunter will remain on the trail as long as the string is followed. In the event the sting disappears, it means that debris such as leaves branches or the like are in the way and the hunter can be aware and remove the debris without falling over the debris. The string can be lifted as well during the process to see if anything heavy is on the string or clearing light weight debris. When attaching the string to the hunter's blind it can be nailed to the structure, glued wrapped around stairs or rungs as mentioned, or by any other convenient method for attaching strings to an enclosure.

In one embodiment, there is a system or kit-of-parts comprising a length of UV fluorescent string, a UV flashlight and instructions (in one embodiment, written or provided in digital format) to utilize the present invention to provide a safe pathway along a hunter's trail to a designated hunting area such as a hunter's blind. The instructions can be detailed as to ways of installing the string, optional configurations depending on the multiplicity of situations possible, how to search for obstructions when the string appears to disappear, and the like.

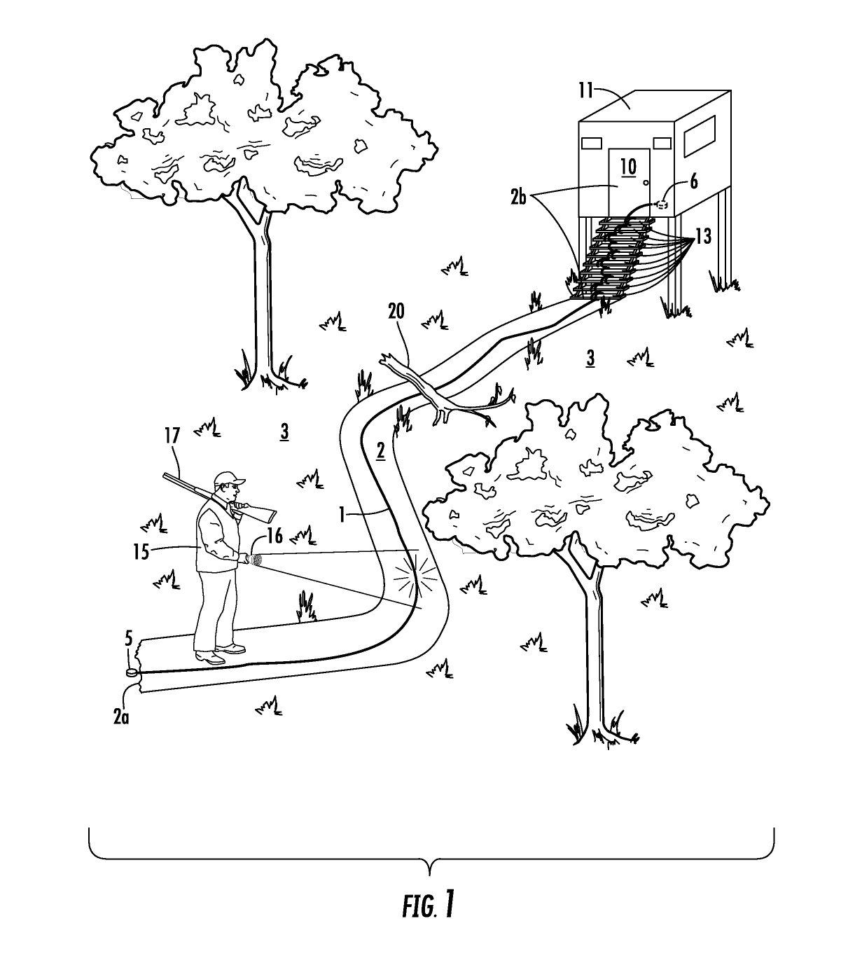

Now referring to the drawings, FIG. 1 is a perspective view of the method of the present invention where a hunter is walking in the dark to an elevated hunter's blind with stairs. In this view, UV fluorescent string 1 is positioned along trail 2 in the woods 3. The string 1 has a first end 5 which is positioned at the start of the trail 2a and ends at the second end 6 at the end of the trail 2b which is either the end of the path itself or the door 10 of hunter's blind 11. In this embodiment, the string 1 is wrapped around each of three stairs 13 of the blind 11. In the method of the invention, the hunter 15 holding UV flashlight 16 and carrying weapon 17 shines the flashlight 16 on string 1 causing it to fluoresce where the light hits the string. When the hunter 15 reaches stairs 13, the hunter will be able to see the width and location of the stairs 13 because string 1 is wrapped around stairs 13.

In this view branch 20 is laying across path 2 and string 1. When the hunter reaches branch 20 the view of the string will disappear, thus indicating that something is on the trail. The hunter can stop and safely remove branch 20 and continue on the hunter's way.

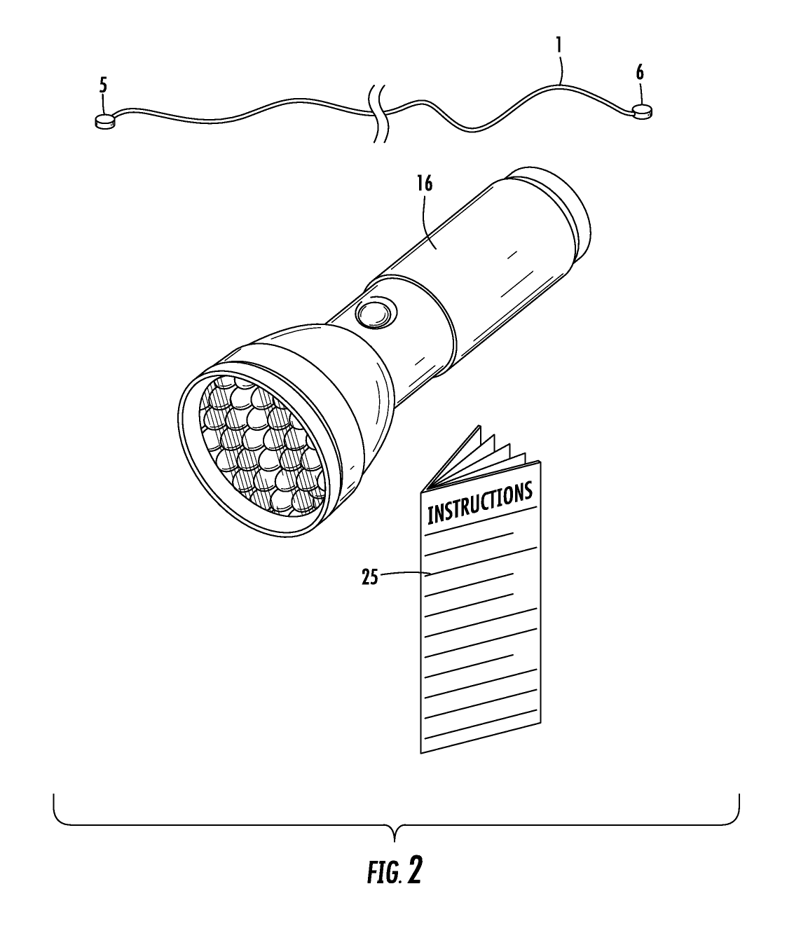

In FIG. 2 there is shown a system or kit-of-parts consisting of a length of UV fluorescent string 1 sufficient to be utilized (either by cutting to make shorter or utilizing multiple lengths to make longer or as is) along a selected trail the hunter wants to use the system on. Also in the kit is a UV flashlight 16 as described above and further there are written instructions 25 which explain to the hunter how to use and install the system string along the pathway and utilize the flashlight 16 to find the hunter's way and in some embodiments climb stairs or rungs.

Those skilled in the art to which the present invention pertains may make modifications resulting in other embodiments employing principles of the present invention without departing from its spirit or characteristics, particularly upon considering the foregoing teachings. Accordingly, the described embodiments are to be considered in all respects only as illustrative, and not restrictive, and the scope of the present invention is, therefore, indicated by the appended claims rather than by the foregoing description or drawings. Consequently, while the present invention has been described with reference to particular embodiments, modifications of structure, sequence, materials and the like apparent to those skilled in the art still fall within the scope of the invention as claimed by the applicant.

What is claimed is:

1. A method of providing a marking of an outdoor trail for a hunter at night, the trail extending from a trail starting point to a hunting area along the trail comprising:
a) selecting string that fluoresces under UV light the string having a first and second end;
b) positioning the first end of the string at the starting point and running a continuous length of the string along the trail and positioning the second end at the hunting area;
c) providing a portable UV flashlight to the hunter; and
d) the hunter shining the light on the string and following along the string from one end of the string to the other end of the string.

2. The method according to claim 1 wherein the hunting area is a hunter's blind.

3. The method according to claim 2 wherein the hunter's blind has stairs or ladder rungs.

4. The method according to claim 3 wherein the string is wrapped around the stairs or ladder rungs.

5. The method according to claim 1 wherein the light is an LED UV flashlight.

6. A system for providing a safe passage for a hunter traversing along an outdoor trail in the dark between a starting point and a hunting area comprising:
a) UV fluorescent string having a first end and a second end of a length sufficient to extend from the starting point to the hunting area along the trail;
b) a portable UV flashlight; and
c) instructions for the hunter for positioning the first end of the string at the starting point and the second end at the hunting area along the trail and utilizing the UV flashlight to find one's way between the starting point and hunting area.

7. The system according to claim 6 wherein the flashlight is a LED UV flashlight.

8. The system according to claim 6 wherein the instructions include wrapping the string around the stairs of a hunter's blind stairs or the rungs of a ladder.
